(19) United States
(12) Patent Application Publication
(10) Pub. No.: US 2018/0197224 A1
(43) Pub. Date: Jul. 12, 2018

(54) IDENTIFYING AN ITEM FROM RESEARCH

(71) Applicant: LENOVO (Singapore) PTE. LTD., New Tech Park (SG)

(72) Inventors: Nathan J. Peterson, Oxford, NC (US); John Carl Mese, Cary, NC (US); Russell Speight VanBlon, Raleigh, NC (US); Arnold S. Weksler, Raleigh, NC (US)

(21) Appl. No.: 15/402,537

(22) Filed: Jan. 10, 2017

(51) Int. Cl. G06Q 30/06

(52) U.S. Cl. CPC G06Q 30/0629; G06Q 30/0613; G06Q 30/0635; G06Q 30/0605

(57) ABSTRACT

For identifying an item from research, a processor identifies a purchase item by monitoring product research. The processor further determines the processor is at a retail venue. In response to the purchase item being available at the retail venue and the purchase item satisfying a notification condition, the processor communicates a notification for the purchase item via a display.

### FIELD

The subject matter disclosed herein relates to research and more particularly relates to identifying an item from research.

### BACKGROUND

### Description of the Related Art

Products are often researched.

### BRIEF SUMMARY

An apparatus for identifying an item from research is disclosed. The apparatus includes a display, a processor, and a memory. The memory stores code executable by the processor. The processor identifies a purchase item by monitoring product research. The processor further determines the apparatus is at a retail venue. In response to the purchase item being available at the retail venue and the purchase item satisfying a notification condition, the processor communicates a notification for the purchase item via the display. The notification includes a purchase item location. A method and computer program product also perform the functions of the apparatus.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1A is a schematic block diagram illustrating one embodiment of a research system;

FIG. 1B is a front view drawing illustrating one embodiment of an electronic device;

FIG. 1C is a front view drawing illustrating one alternate embodiment of an electronic device;

FIG. 2A is a schematic block diagram illustrating one embodiment of purchase item data;

FIG. 2B is a schematic block diagram illustrating one embodiment of research data;

FIG. 2C is a schematic block diagram illustrating one embodiment of a notification;

FIG. 3A is a schematic block diagram illustrating one embodiment of calculation data;

FIG. 3B is a schematic block diagram illustrating one embodiment of a retail venue;

FIG. 4 is a schematic block diagram illustrating one embodiment of a computer;

FIG. 5A is a schematic flow chart diagram illustrating one embodiment of a purchase item notification method;

FIG. 5B is a schematic flowchart diagram illustrating one embodiment of a product research method; and

FIG. 5C is a schematic flow chart diagram illustrating one embodiment of a co-shopping method.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. These codes may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

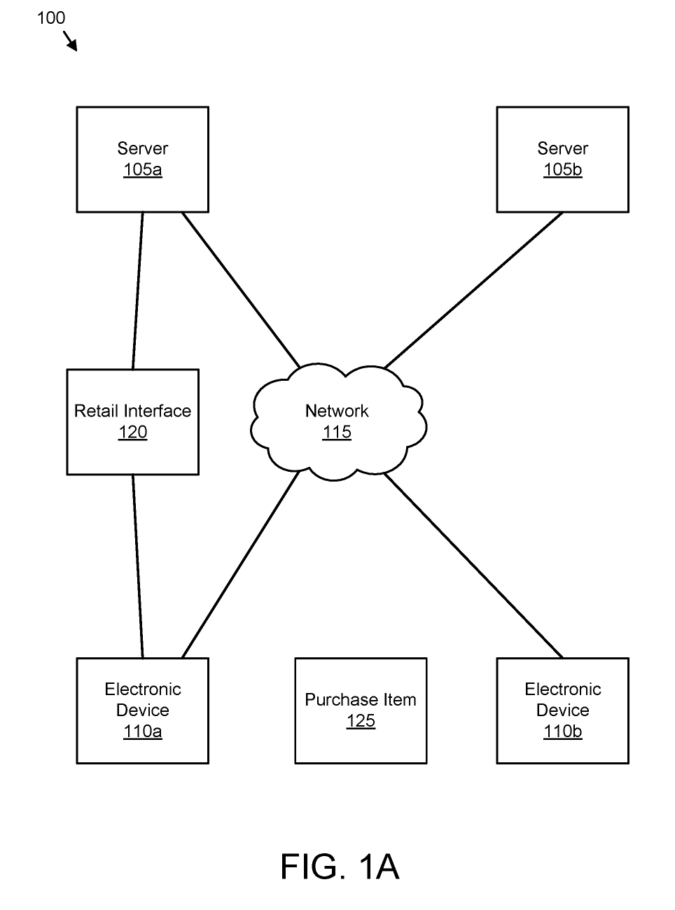

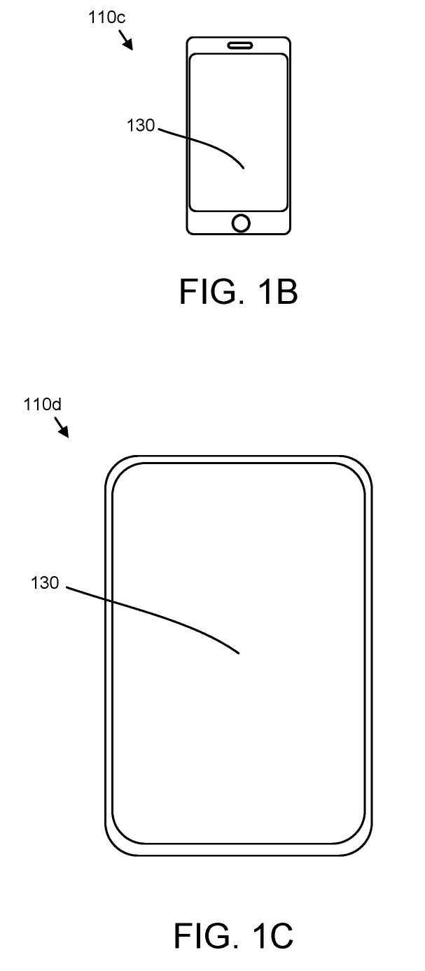

FIG. 1A is a schematic block diagram illustrating one embodiment of a research system 100. The system 100 may monitor product research and identify a purchase item 125 from the product research. In addition, the system 100 may communicate a notification for the purchase item 125. In the depicted embodiment, the system 100 includes one or more servers 105, one or more electronic devices 110, and a network 115. In one embodiment, the system 100 includes a retail interface 120.

The network 115 may include the Internet, a mobile telephone network, a local area network, a wide-area network, a Wi-Fi network, or combinations thereof. A user may employ the electronic device 110 to perform product research. The product research may include a review of one or more potential purchase items 125. In addition, the product research may include a purchase history, a purchase list, or the like.

The electronic device 110 may access the one or more servers 105 through the network 115 to perform the product research. For example, the electronic device 110 may be used to access product specifications, product reviews, product pricing, product warranties, and the like.

Unfortunately, although the electronic device 110 performed the product research, the electronic device 110 has been unable to draw inferences from the product research and act on those inferences. In addition, the electronic device 110 has been unable to enable a user to act on the inferences from the product research. The embodiments described herein identify a purchase item 125 by monitoring the product research. In addition, the embodiments determine that the electronic device is at a retail venue and in response to the purchase item 125 being available at the retail venue and the purchase item 125 satisfying the notification condition, the embodiments communicate a notification for the purchase item 125 that includes the purchase item location. As a result, the electronic device 110 may automatically communicate the notification if the identified purchase item 125 is available near the electronic device 110.

In one embodiment, the electronic device 110 may determine that the purchase item 125 is available at the retail venue by querying the retail interface 120. The retail interface 120 may communicate with a server 105a and determined from the server 105 whether the purchase item 125 is available and other information including a purchase price and the location of the purchase item.

FIG. 1B is a front view drawing illustrating one embodiment of a mobile telephone electronic device 110c. FIG. 1C is a front view drawing illustrating one embodiment of a tablet electronic device 110c. Other embodiments of electronic devices 110 may be employed. Each electronic device 110c/d includes a display 130. The display 130 may present a notification as will be described hereafter.

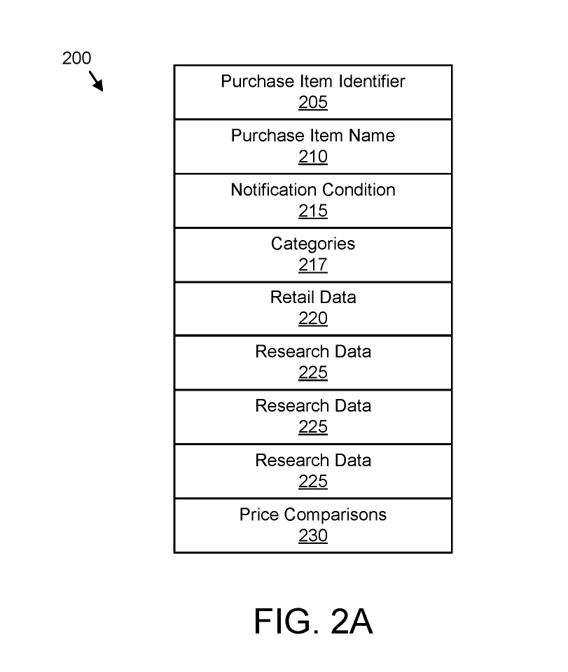

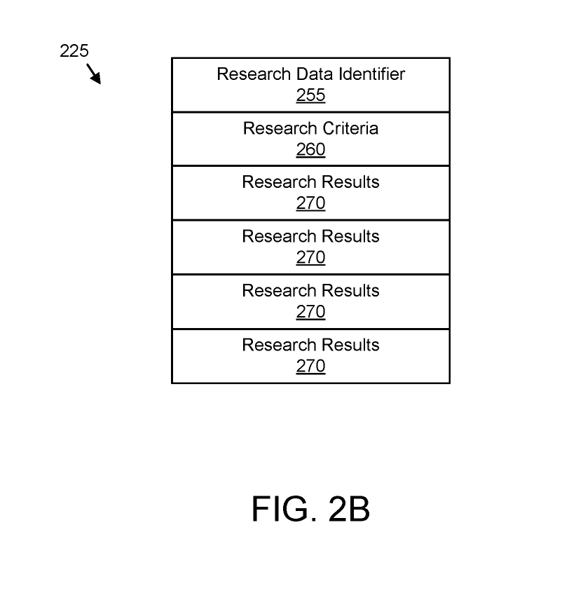

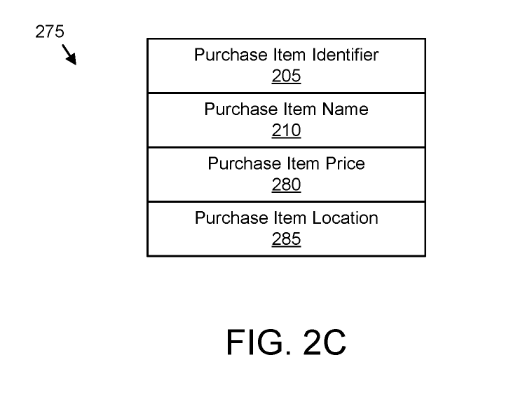

FIG. 2A is a schematic block diagram illustrating one embodiment of purchase item data 200. The purchase item data 200 may describe a purchase item 125. The purchase item data 200 may be organized as a data structure in a memory. In the depicted embodiment, the purchase item data 200 includes a purchase item identifier 205, a purchase item name 210, a notification condition 215, categories 217, retail data 220, a plurality of research data 225, and price comparisons 230.

The purchase item identifier 205 may uniquely identify the purchase item 125. In one embodiment, the purchase item identifier 205 is created in response to identifying the purchase item 125. The purchase item identifier 205 may be an alphanumeric string. In a certain embodiment, the purchase item identifier 205 is a Shopkeepers Unit (SKU).

The purchase item name 210 may identify the purchase item 125 to the user. In one embodiment, the purchase item name 210 is parsed from search terms employed by the user during product research. Alternatively, the purchase item name 210 may be parsed from the research data 225.

The notification condition 215 may specify criteria for communicating a notification through the electronic device 110 if the purchase item 125 is available at the retail venue. In one embodiment, the notification condition 215 includes a price threshold. The purchase item 125 may satisfy the notification condition 215 if the purchase item price 280 is less than the price threshold. The price threshold may be determined from the research data 225 and/or price comparisons 230. In one embodiment, the price threshold is a lowest price from the research data 225 and/or price comparisons 230 for the purchase item 125. Alternatively, the price threshold is within a price range of 10 to 20% of the lowest price from the research data 225 and/or price comparisons 230 for the purchase item 125.

In one embodiment, the notification condition 215 includes a freshness threshold. The freshness threshold may be in the range of 1 to 14 days from a current time. The purchase item 125 may satisfy the notification condition 215 if most recent research results for the research data 225 have a timestamp that is more recent than the freshness threshold. In a certain embodiment, both the price threshold and the freshness threshold must be satisfied for the purchase item 125 to satisfy the notification condition 215.

The categories 217 may include one or more product categories related to the purchase item 125 that are parsed from the research data 225. In one embodiment, the categories 217 include all product categories from the research data 225.

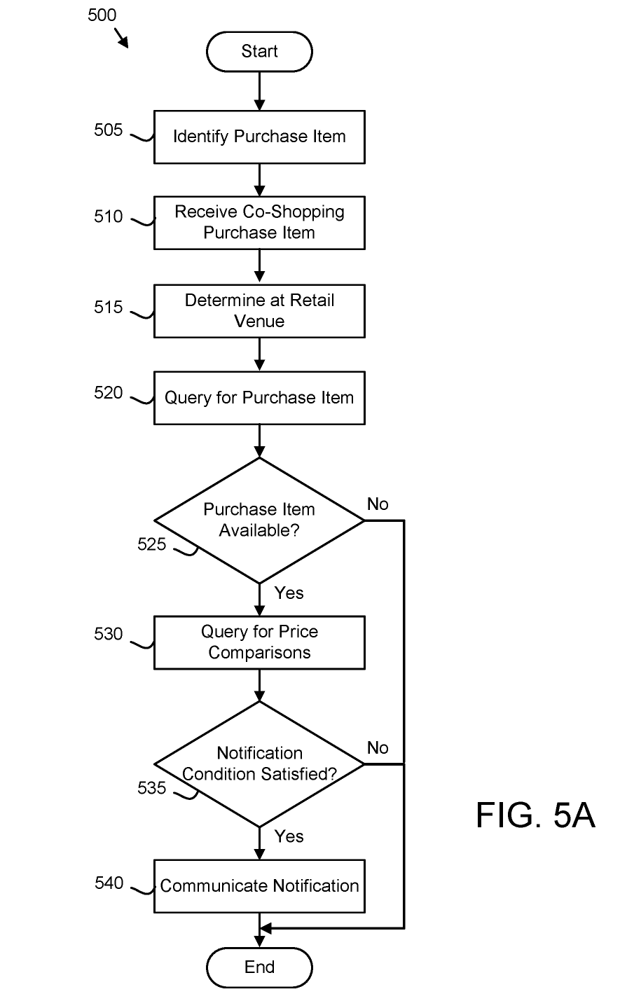

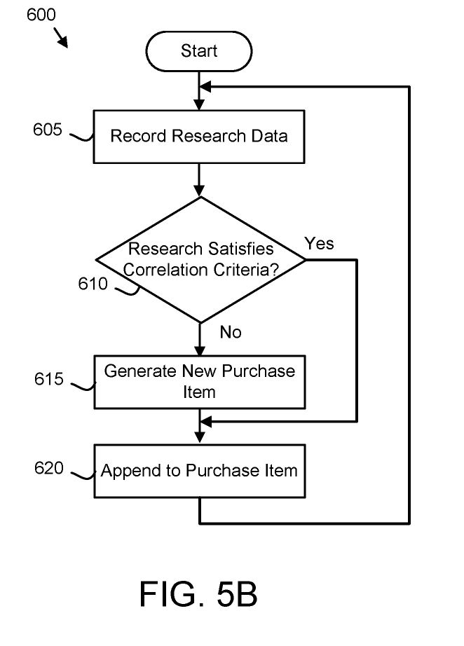

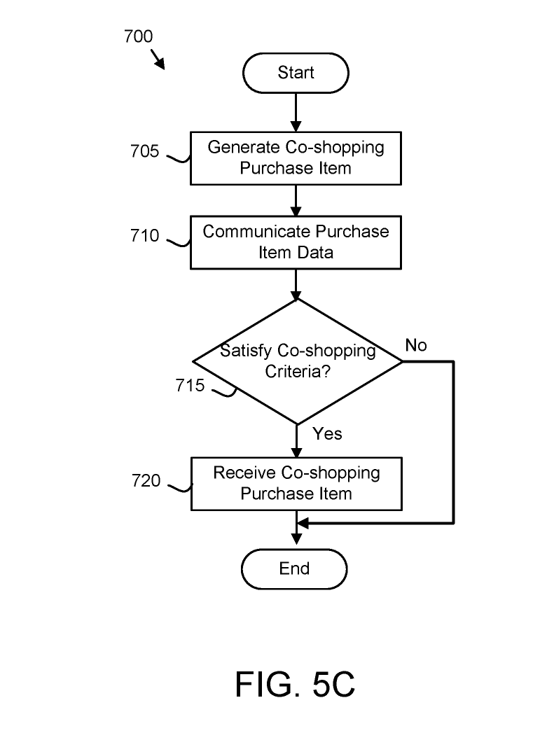

The retail data 220 may be retrieved through the retail interface 120 from the server 105 for a retail venue. The retail data 220 may include a purchase item price. In addition, the retail data 220 may include a purchase item location. The plurality of research data 225 may be recorded during product research. The research data 225 is described in more detail in FIG. 5B.

The price comparisons 230 may record prices of the purchase item 125 from various sources including the research data 225. The price comparisons 230 may be used to determine if the purchase item 125 at a retail venue 135 satisfies the notification condition 215.

FIG. 2B is a schematic block diagram illustrating one embodiment of the research data 225. The research data 225 may be organized as a data structure in a memory. In the depicted embodiment, the research data 225 includes a research data identifier 255, research criteria 260, and one or more research results 270.

The research data identifier 255 may uniquely identify the research data 225. The research data identifier 255 may be recorded as an alphanumeric string when the research data 225 is created. The research criteria 260 may include one or more of search terms, search sources, and the like. For example, all criteria that is used to generate search results may be recorded as the research criteria 260.

Each research result 270 may record a search result generated by the research criteria 260. In one embodiment, a research result 270 records only search result items that are selected and/or viewed by the user on the electronic device 110. Alternatively, the research result 270 may record all search results that are retrieved using the research criteria 260. In a certain embodiment, the research result 270 records a number of times and a duration for each time that a search result item is viewed by the user.

FIG. 2C is a schematic block diagram illustrating one embodiment of a notification 275. The notification 275 may be generated by the electronic device 110 and formatted and presented on a display 130 of the electronic device 110. The notification 275 may be organized as a data structure in a memory. In the depicted embodiment, the notification 275 includes the purchase item identifier 205, the purchase item name 210, the purchase item price 280, and the purchase item location 285. The purchase item location 285 may include a name of the retail venue.

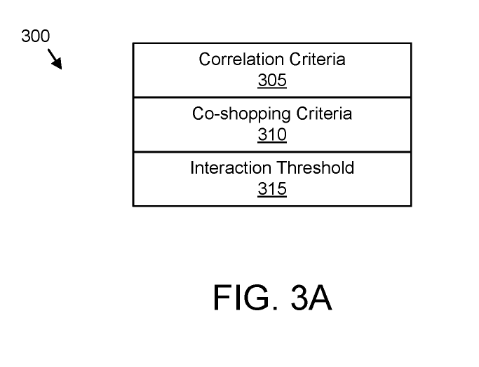

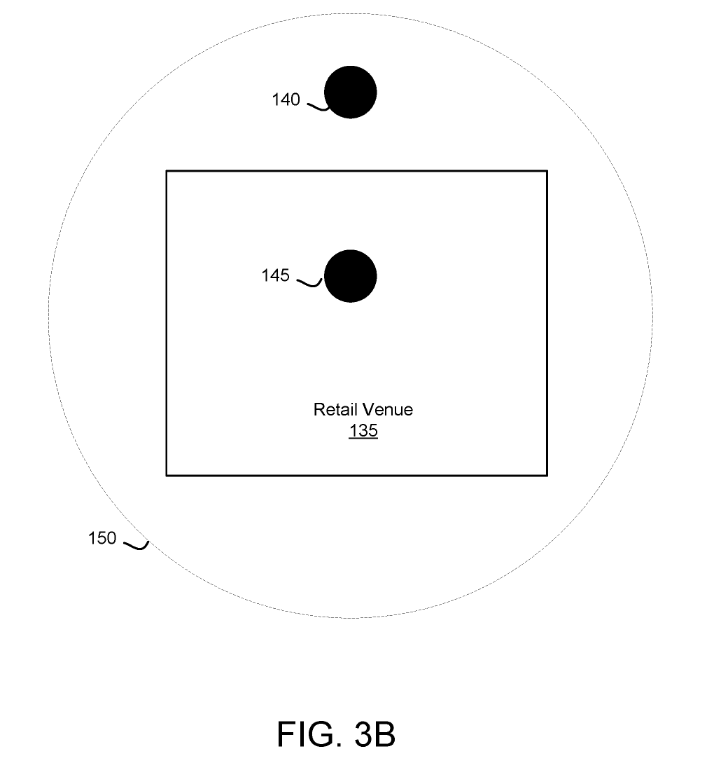

FIG. 3A is a schematic block diagram illustrating one embodiment of calculation data 300. The calculation data 300 may be used in identifying the purchase item 125 and in determining if the purchase item 125 satisfies the notification condition 215. The calculation data 300 may be organized as one or more algorithms and/or parameters in a memory. In the depicted embodiment, the calculation data 300 includes correlation criteria 305, co-shopping criteria 310, and an interaction threshold 315.

In one embodiment, the correlation criteria 305 specifies if research data 225 may be appended to the purchase item data 200 of a purchase item 125. The correlation criteria 305 may be satisfied if the research data 225 includes the purchase item name 210. In addition, the research data 225 may satisfy the correlation criteria 305 if a ratio of a weighted sum of shared categories 217 for the research data 225 and the purchase item 125 to a weighted sum of categories 217 for the research data 225 is less than a correlation threshold.

The co-shopping criteria 310 may specify if a co-shopping purchase item 125 for a third-party electronic device 110b should be received the electronic device 110a. In one embodiment, the co-shopping criteria 310 is satisfied if interactions between the electronic device 110a and the third-party electronic device 110b exceed the interaction threshold 315. In one embodiment, the interaction threshold 315 is in the range of 5 to 25 interactions per week.

FIG. 3B is a schematic block diagram illustrating one embodiment of a retail venue 135. The retail venue 135 may be a store, a shopping center, a mall, and the like. In one embodiment, the retail venue 135 is a physical store. The electronic device 110 may be at the retail venue 135 if the electronic device 110 is at an interior location 145 within the physical store. Alternatively, the electronic device 110 may be at the retail venue 135 if the electronic device 110 is at a location 145 within the shopping center and/or the mall.

In an alternate embodiment, the electronic device 110 may be at the retail venue 135 if the electronic device 110 is at a location 140 that is within a co-location radius 150 of the retail venue 135.

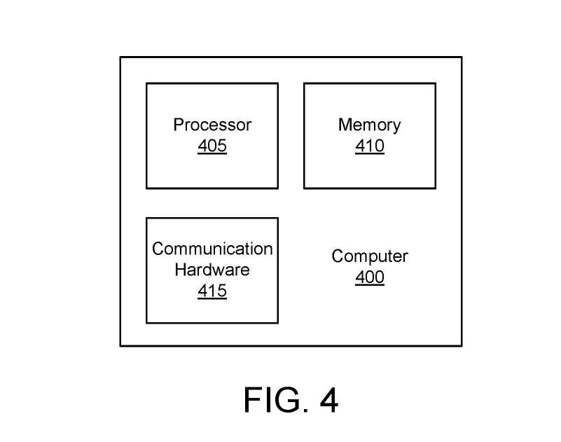

FIG. 4 is a schematic block diagram illustrating one embodiment of a computer 400. The computer 400 may be embodied in the electronic devices 110, the servers 105, and/or the retail interface 120. In the depicted embodiment, the computer 400 includes a processor 405, memory 410, and communication hardware 415. The memory 410 may include a semiconductor storage device, hard disk drive, an optical storage device, a micromechanical storage device, or combinations thereof. The memory 410 may store code. The processor 405 may execute the code. The communication hardware 415 may communicate with other devices such as the network 115.

FIG. 5A is a schematic flow chart diagram illustrating one embodiment of a purchase item notification method 500. The method 500 communicates a notification 275 for a purchase item 125. The method 500 may be performed by a computer 400 such as the electronic device 110, and/or the processor 405 of the computer 400.

The method 500 starts, and in one embodiment, the processor 405 identifies 505 the purchase item 125 by monitoring product research. The processor 405 may record the research data 225 from the product research and identify 505 the purchase item 125 from the research data 225. In addition, the processor 405 may create the purchase item data 200 for the identified 505 purchase item 125. The identification 505 of the purchase item 125 is described in more detail in FIG. 5B.

In one embodiment, the processor 405 receives 510 a co-shopping purchase item 125 from the third-party electronic device 110b. The processor 405 may receive 510 the co-shopping purchase item 125 if the co-shopping criteria 310 is satisfied. In one embodiment, the processor 405 may look for either the purchase item 125 and/or the co-shopping purchase item 125 at retail venues 135. The determination of the co-shopping purchase item 125 is described in more detail in FIG. 5C.

The processor 405 may determine 515 that the electronic device 110a is at the retail venue 135. The electronic device 110 may be at the retail venue 135 if the electronic device 110 is at an interior location 145 within the physical store. Alternatively, the electronic device 110 may be at the retail venue 135 if the electronic device 110 is at a location 140 that is within the co-location radius 150 of the retail venue 135.

The processor 405 may query 520 the retail venue 135 for the purchase item 125. In one embodiment, the processor 405 communicates through the retail interface 120 to query 520 the retail venue 135. In alternate embodiment, the processor 405 communicates through the network 115 to query 520 the retail venue 135. The processor 405 may communicate with the server 105 of the retail venue 135.

The processor 405 may query 520 the retail venue 135 with one or more of the purchase item identifier 205 and/or the purchase item name 210. The server 105 of the retail venue 135 may respond with the retail data 220. In one embodiment, the retail data 220 includes one or more of the purchase item identifier 205, the purchase item name 210, the purchase item price 280, and/or the purchase item location 285.

The processor 405 may determine 525 if the purchase item 125 is available from the retail data 220. If the purchase item 125 is not available, the method 500 ends. If the purchase item 125 is available from the retail venue 135, the processor 405 may query 530 for price comparisons 230. In one embodiment, the processor 405 queries 530 one or more servers 105 for the price comparisons 230.

The processor 405 may determine 535 if the notification condition 215 is satisfied. In one embodiment, the notification condition 215 is satisfied if the purchase item price 280 is less than the price threshold. In addition, the notification condition 215 may be satisfied if the most recent timestamp of the research data 215 is more recent than the freshness threshold.

If the notification condition 215 is not satisfied, the method 500 ends. If the notification condition 215 is satisfied and the purchase item 125 is available at the retail venue 135, the processor 405 may communicate 540 the notification 275 for the purchase item 125 through the electronic device 110 via the display 130 and the method 500 ends. The processor 405 may format the notification 275 for presentation. In one embodiment, the processor 405 further communicates an audible notification such as a tone through the electronic device 110.

FIG. 5B is a schematic flowchart diagram illustrating one embodiment of a product research method 600. The method 600 may identify the purchase item 125 from the product research. The method 600 may be performed by a computer 400 such as the electronic device 110, and/or the processor 405 of the computer 400.

The method 600 starts, and in one embodiment, the processor 405 records 605 the research data 225 while the electronic device 110 is engaged in product research. The research data 225 may embody the product research. In one embodiment, a user may engage in product research on a plurality of electronic devices 110 and the research data 225 may be shared between the plurality of electronic devices 110.

The processor 405 may determine 610 if the research data 225 satisfies the correlation criteria 305 for the purchase item 125 and the associated purchase item data 200. The correlation criteria 305 may be satisfied if the research data 225 includes the purchase item name 210. In addition, the research data 225 may satisfy the correlation criteria if a ratio of a weighted sum of shared categories 217 for the research data 225 and the purchase item 125 to a weighted sum of categories 217 for the research data 225 is less than a correlation threshold.

If the research data 225 does not satisfy the correlation criteria 305 for the purchase item 125, the processor 405 may generate 615 a new purchase item 125 and associated purchase item data 200. The processor 405 may parse the purchase item identifier 205, the purchase item name 210, and one or more categories 217 from the research data 225 and store the purchase item data 200 in the memory 410. The processor 405 may further append 620 the research data 225 to the purchase item data 200. If the research data 225 satisfies the correlation criteria 305, the processor 405 appends 620 the research data 225 to the purchase item data 200 and loops to record 605 additional research data 225. As a result, the method 600 continually records 605 the research data 225 from product research and organizes the research data 225 into purchase item data 200.

FIG. 5C is a schematic flow chart diagram illustrating one embodiment of a co-shopping method 700. The method 700 may determine if a co-shopping purchase item 125 for the third-party electronic device 110b satisfies the co-shopping criteria 310 and receive the co-shopping purchase item 125. The method 700 may be performed by a computer 400 such as the electronic device 110, and/or the processor 405 of the computer 400.

The method 700 starts, and in one embodiment, the processor 405 of the third-party electronic device 110b generates 705 the co-shopping purchase item 125 and the associated purchase item data 200. The processor 405 may generate 705 the co-shopping purchase item 125 as described in FIG. 5B.

The processor 405 of the third-party electronic device 110b further communicates 710 the purchase item data 200 for the co-shopping purchase item 125 to the electronic device 110a. The processor 405 of the electronic device 110a determines 715 if the co-shopping purchase item 125 for the third-party electronic device 110b satisfies the co-shopping criteria 310. In one embodiment, the co-shopping criteria 310 is satisfied if interactions of the electronic device 110a with the third-party electronic device 110b exceed the interaction threshold.

If the co-shopping criteria 310 is not satisfied, the method 700 ends. If the co-shopping criteria 310 is satisfied, the processor 405 of the electronic device 110a receives 720 the co-shopping purchase item 125 embodied in the purchase item data 200 for the co-shopping purchase item 125 and the method 700 ends. As a result, the electronic device 110a may search for opportunities to purchase the co-shopping purchase item 125 at retail venues 135.

The embodiments identify the purchase item 125 by monitoring the product research. In addition, the embodiments determine that the electronic device 110 is at a retail venue 135. The embodiments may query the retail venue 135 and determine that the purchase item 125 is available for purchase at the retail venue 135. As a result, the embodiments automatically identify the desired purchase item 125 and that the desired purchase item 125 is available for purchase at the retail venue 135

In response to the purchase item 125 been available at the retail venue 135 and the purchase item 125 satisfying the notification condition 215, the embodiments communicate the notification 275 for the purchase item 125 through the electronic device 110. The user may receive the notification 275 automatically without creating the criteria for the notification 275.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a display;
a processor;
a memory that stores code executable by the processor to:
identify a purchase item by monitoring product research;
determine the apparatus is at a retail venue; and
in response to the purchase item being available at the retail venue and the purchase item satisfying a notification condition, communicate a notification for the purchase item comprising a purchase item location via the display.

2. The apparatus of claim 1, wherein the notification further comprises a purchase item price and the purchase item location comprises a name of the retail venue.

3. The apparatus of claim 1, wherein the code is further executable by the processor to query the retail venue for the purchase item.

4. The apparatus of claim 1, wherein the code is further executable by the processor to query for price comparisons.

5. The apparatus of claim 1, wherein the code is further executable by the processor to:
record research data from the product research;
determine if the research data satisfies correlation criteria for the purchase item;
in response to the research data satisfying the correlation criteria for the purchase item, append the research data to the purchase item; and
in response to the research data not satisfying the correlation criteria for the purchase item, generate a new purchase item.

6. The apparatus of claim 5, wherein the research data satisfies the correlation criteria if a ratio of a weighted sum of shared categories for the research data and the purchase item to a weighted sum of categories for the research data is less than a correlation threshold.

7. The apparatus of claim 1, wherein the code is further executable by the processor to:
determine if a co-shopping purchase item for a third-party electronic device satisfies a co-shopping criteria; and
in response to the co-shopping purchase item satisfying the co-shopping criteria, receive the co-shopping purchase item.

8. The apparatus of claim 7, wherein the co-shopping criteria is satisfied if interactions with the third-party electronic device exceed an interaction threshold.

9. A method comprising:
identifying, by use of a processor, a purchase item by monitoring product research;
determining an electronic device is at a retail venue; and
in response to the purchase item being available at the retail venue and the purchase item satisfying a notification condition, communicating a notification for the purchase item comprising a purchase item location.

10. The method of claim 9, wherein the notification further comprises a purchase item price and the purchase item location comprises a name of the retail venue.

11. The method of claim 9, the method further querying the retail venue for the purchase item.

12. The method of claim 9, the method further querying for price comparisons.

13. The method of claim 9, the method further:
recording research data from the product research;
determining if the research data satisfies correlation criteria for the purchase item;
in response to the research data satisfying the correlation criteria for the purchase item, appending the research data to the purchase item; and
in response to the research data not satisfying the correlation criteria for the purchase item, generating a new purchase item.

14. The method of claim 13, wherein the research data satisfies the correlation criteria if a ratio of a weighted sum of shared categories for the research data and the purchase item to a weighted sum of categories for the research data is less than a correlation threshold.

15. The method of claim 9, the method further:
determining if a co-shopping purchase item for a third-party electronic device satisfies a co-shopping criteria; and
in response to the co-shopping purchase item satisfying the co-shopping criteria, receiving the co-shopping purchase item.

16. The method of claim 15, wherein the co-shopping criteria is satisfied if interactions with the third-party electronic device exceed an interaction threshold.

17. A program product comprising a computer readable storage medium that stores code executable by a processor, the executable code comprising code to perform:
identifying a purchase item by monitoring product research;
determining an electronic device is at a retail venue; and
in response to the purchase item being available at the retail venue and the purchase item satisfying a notification condition, communicating a notification for the purchase item comprising a purchase item location.

18. The program product of claim 17, the processor further:
recording research data from the product research;
determining if the research data satisfies correlation criteria for the purchase item;
in response to the research data satisfying the correlation criteria for the purchase item, appending the research data to the purchase item; and
in response to the research data not satisfying the correlation criteria for the purchase item, generating a new purchase item.

19. The program product of claim 18, wherein the research data satisfies the correlation criteria if a ratio of a weighted sum of shared categories for the research data and the purchase item to a weighted sum of categories for the research data is less than a correlation threshold.

20. The program product of claim 17, the processor further:
determining if a co-shopping purchase item for a third-party electronic device satisfies a co-shopping criteria; and
in response to the co-shopping purchase item satisfying the co-shopping criteria, receiving the co-shopping purchase item.
